(19) United States
(12) Patent Application Publication
(10) Pub. No.: US 2005/0168854 A1
(43) Pub. Date: Aug. 4, 2005

(54) Binder unit

(76) Inventor: Jacqueline Marie Steaday, Chatham, NJ (US)

Correspondence Address: Jacqueline M. Steady, Esq., 1021 Cape May Avenue, Cape May, NJ, 08204, US

(21) Appl. No.: 10/847,140

(22) Filed: May 17, 2004

Related U.S. Application Data
(63) Continuation-in-part of application No. 10/770,813, filed on Feb. 3, 2004.
(60) Provisional application No. 60/561,217, filed on Apr. 9, 2004.

(51) Int. Cl. G02B 7/182

(52) U.S. Cl. 359/879; 359/871

(57) ABSTRACT

A binder mirror having a base member secured to a mirror member. The mirror member rotates around a flat plane of the base member. Alternately, a base member and a top member are fastened. A base member may include a variety of elements. A top member and a base member may both include a mirror. Relative rotation of the pieces may vary.

This application is a Continuation in Part application of Ser. No. 10/770,813 filed Feb. 3, 2004. Priority for this application includes provisional application 60/561217, filed Apr. 9, 2004.

### BACKGROUND OF THE INVENTION

In the field of mirrors, the present invention is designed to provide a mirror that has an edge region with an aperture for receipt by a ring of a binder.

Mirrors have been formed in the shape of a compact This includes one member displaceable relative to a second member and including a mirror surface on at least one of the displaceable surfaces. The problem arises with mirrored compacts is that it is too cumbersome to hold a compact, a type of makeup, not including a mirror, and apply makeup with a brush or hold a compact and brush one's hair.

### SUMMARY OF THE INVENTION

Accordingly it is an advantage of the present invention that a mirror is provided that is securable in a binder.

Another advantage of the present invention is that a mirror is provided that is rotatable relative to a base member securable by a ring of a binder through at least one aperture where the mirror member does not overlap any of the aperture(s) of the base member and has complete desired rotation around the base member from a closed position to an open position and the rotation of the mirror member relative to the base member is free from interruption of the ring of the binder when secured to such a ring.

Yet another advantage of the present invention is that a binder mirror is provided that includes a mirror rotatable approximately 180 degrees relative to a base of binder mirror.

Another advantage of the present invention is that a binder mirror includes an opening device to ease opening of a mirror member relative to a base member of a binder mirror.

An alternate advantage of the invention is to include a base member with a mirror member rotatable above said base member, the rotation parallel to a plane above said base member.

Yet another alternate advantage of the invention is to include an opening enhancement.

Yet another alternate advantage is to include a swivel stop and or a rotation limiter.

An additional alternate advantage is to include a compact rotatable above a base member with a mirror member rotatable around a base of a compact member.

Yet another additional alternate advantage includes a swivel stop.

Yet another alternate additional alternate advantage includes swivel stops and or fastening devices with rotation limiters.

Still another variation provides the advantage where the top member and the base member define a compartment there between.

Yet another variation provides the advantage where a base member includes additional elements.

### BRIEF DESCRIPTION OF THE DRAWINGS

FIG. 1 is a front view of an open binder mirror according to the best mode of the invention;

FIG. 2 is a front view of a closed binder mirror according to the best mode of the invention;

FIG. 3 shows a three dimensional view of a base member;

FIG. 4a shows a three dimensional view of an integral mirror member and FIGS. 4b and 4c show a two piece arrangement of a mirror member;

FIG. 5a shows a top view of a base member and FIGS. 5b-5e show cross sectional views of the base member;

FIG. 6a shows a top view of another base member and FIGS. 6b and 6c show cross sectional views of this mirror member;

FIG. 7a shows a mirror base and FIGS. 7b and 7c show cross sectional views of a mirror base;

FIG. 8 shows a fastening device for the best mode of the invention;

FIGS. 9a-9b show post and rod arrangements;

FIG. 10 shows an alternate fastening device;

FIGS. 11a-11d show various opening features;

FIG. 12 shows a base member with an indentation;

FIGS. 13A-13D show a base member for integral fastening;

FIGS. 14A-14E show a top member for integral fastening;

FIGS. 15A-15F show a base member for integral fastening with a plurality of protrusions and a cover;

FIGS. 16-17 show base members with various elements;

FIGS. 18-19 show a base member and top members for defining compartments there between;

FIG. 20 shows a binder mirror with mirror in both the top member and the base member;

FIG. 21 is a top view of a second embodiment of the invention;

FIG. 22 is a top view of a base member according to the second embodiment of the invention;

FIG. 23 is a top view of a mirror member according to the second embodiment of the invention;

FIGS. 24-25 show a binder mirror according to the second embodiment of the invention with opening features;

FIGS. 26-27 show a binder mirror according to the second embodiment of the invention with opening features and a swivel stop;

FIG. 28 shows a binder mirror according to a third embodiment of the invention in an open rotation, closed mirror position; and

FIG. 29 shows a binder mirror according to the third embodiment of the invention in an open rotation, open mirror position.

### DETAILED DESCRIPTION OF THE INVENTION

The present invention is directed to providing a mirror for a cosmetics case having a binder or simply a binder arrangement. The entire contents of U.S. Pat. No. 6,164,451, issued Dec. 26, 2000 to Sherman, titled, “COSMETICS CASE,” is incorporated herein by reference.

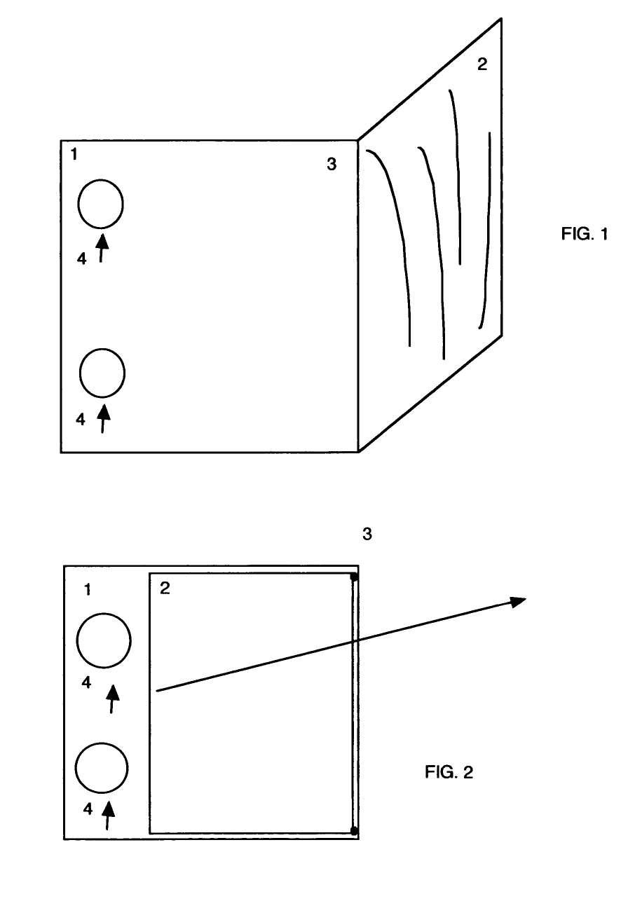

The best mode for carrying out the invention is shown in FIG. 1. FIG. 1 shows a binder mirror in an open position. The binder mirror includes a base member 1. Base member 1 is three dimensional, has four edges and is shaped in the form of a rectangle. Base member 1 includes at least one aperture 4 for receiving a ring of a binder (not shown). A plurality of apertures 4 are shown in FIG. 1. Typically a binder mirror according to this embodiment includes 2 or 3 apertures, although the number of apertures is not limited to those amounts. Apertures 4 are located along a first edge of edges of the base member. Mirror member 2 is three dimensional and includes a reflective surface or a mirror surface on one side of the mirror member. Base member 1 and mirror member 2 are joined by fastening device 3, discussed below. FIG. 2 shows a binder mirror according to FIG. 1 in a closed position.

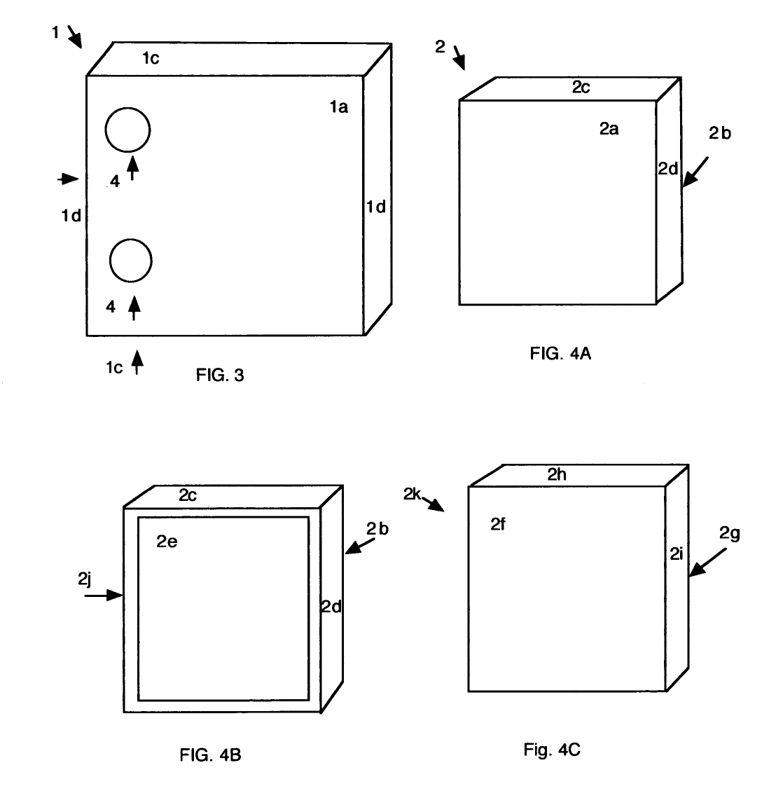

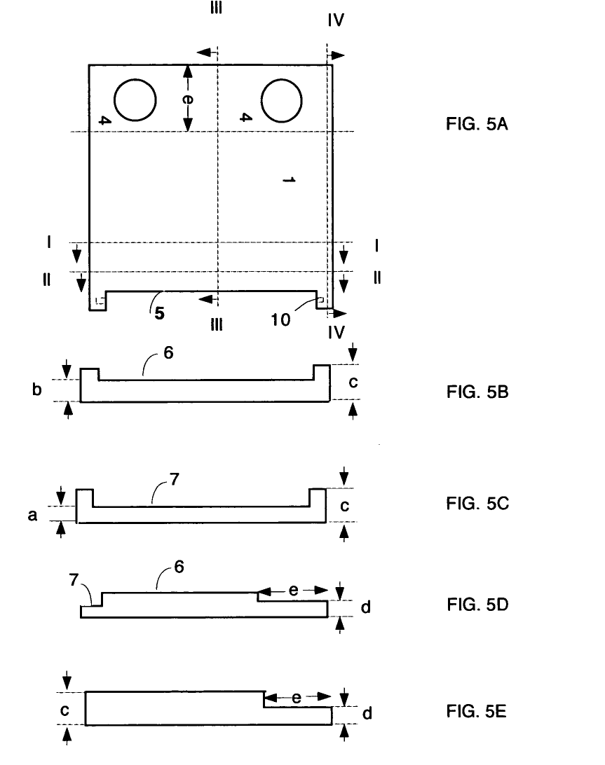

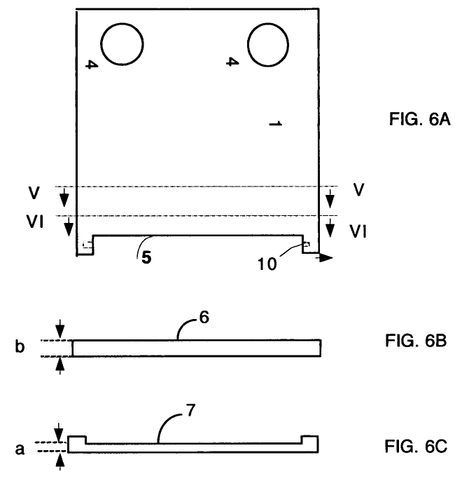

FIG. 3 shows base member 1 having top surface 1a, back surface 1b side surfaces 1c and Id and apertures 4. FIG. 4a shows mirror member 2 having a top surface 2a, back surface 2b, and side surfaces 2c and 2d. Typically mirror member 2 is two separate pieces attached by a binding agent, such as adhesive, a binder, glue or molding, for examples. FIG. 4b shows the base of the mirror member 2j having a recessed portion for receiving a mirror. Top surface 2e of the mirror base 2j is attached to a mirror. FIG. 4c shows a typical three dimensional mirror 2k having top reflective surface 2f back surface 2g, and side surfaces 2h and 2i. FIGS. 5a-5e and 6a-6c show base member 1 and mirror base 2j altered from the shapes shown in FIGS. 3 and 4a-4c to include design features to arrive at the fastening device of FIG. 1. Typically base member 1 and mirror member 2 are a rigid material such as metal, plastic, acrylic, rubber, or reinforced rubber, and may include outward ornamentation such as polished stones, beading and leather. Base member 1 and mirror member 2 may be semi rigid with elasticity as desired and may included the stated materials alone or in combination.

FIG. 5a shows a top view of base member 1 including notch 5 and recesses 10. Recesses 10 receive a fastening device, discussed in more detail below. FIG. 5b shows a cross sectional view along line I-I in FIG. 5a and FIG. 5c shows a cross sectional view along line II-II in FIG. 5a. Cross sectional views shown in FIGS. 5b and 5c show a stepped region of base member 1 where the steps have heights equal to “a” or “b.” Base member 1 includes notch 5 and the stepped region shown by the cross section so that mirror member 2 can be received and mirror member 2 is rotatable between a closed position and an open position. Typically, the height of “a” is less than the height of “b” so that base member 1 allows a protruding rounded side region to rest or be located about the stepped region and a top surface of a mirror member or a mirror base to rest on or be located around the base member. A stepped region can limit a degree of rotation of mirror member 2 around a plane parallel to base member 1. For example, a stepped region may limit relative rotation to approximately 90 degrees, 180 degrees or 270 degrees. An angled region next to notch 5 also would limit a degree of rotation of mirror member 2 relative to base member 1, for examples, rotation may be limited to approximately 90 degrees, 180 degrees or 270 degrees.

FIGS. 5d and 5e show cross sectional views along lines III-III and IV-IV in FIG. 5a. FIG. 5a shows the width of aperture area of the base member equal to “e.” The aperture area includes at least the region of the base member that surrounds apertures 4. The minimal requirements of the aperture area is the area from each aperture to the closest two or three side surfaces of the base member, for example. An aperture area may also extend in a direction opposite a direction to a nearest side, as shown as “e” in FIG. 5a. FIG. 5d shows the height of the aperture region is equal to “d.” Height “d” may vary according to the aesthetics of the situation. For instance, height “d” may be less than the height of an adjacent region as shown in FIG. 5a. Of course, there may be the occasion where height “d” is greater than height “b” or equal thereto, for examples. FIG. 5d shows a cross sectional view of the base member including a stepped region for receiving mirror member 2. FIG. 5e shows a cross sectional view of an edge region of base member 1 that does not include the stepped region. This edge region has a height equal to “c” so that the edge region comfortably includes a recess and is aesthetically pleasing. The above base member mates with mirror member 2.

A raised edge region “c” allows mirror member 2 to mate with base member 1. The edge region may be designed so that the aperture region mates with the mirror member 2 around the side regions of mirror member 2 that are not included with the fastening device 3. A raised edge region “c” having a height greater than “b” and an aperture region having a height varying from “b” are not required. If heights “b,” “c,” and “d” equal one another a region of mirror member 2 may rest on base member 1, as discussed below.

FIGS. 6a-6c show base member 1 having a notch 5 and a single stepped region. This design allows mirror member 2 to rest on base member 1. Cross sectional view V-V of FIG. 6a shown in FIG. 6b shows the height of the base member that allows a mirror member to rest thereon. Cross sectional view VI-VI shown in FIG. 6c shows the stepped region of a base member. The stepped region receives a side region of a base of a mirror member, discussed below.

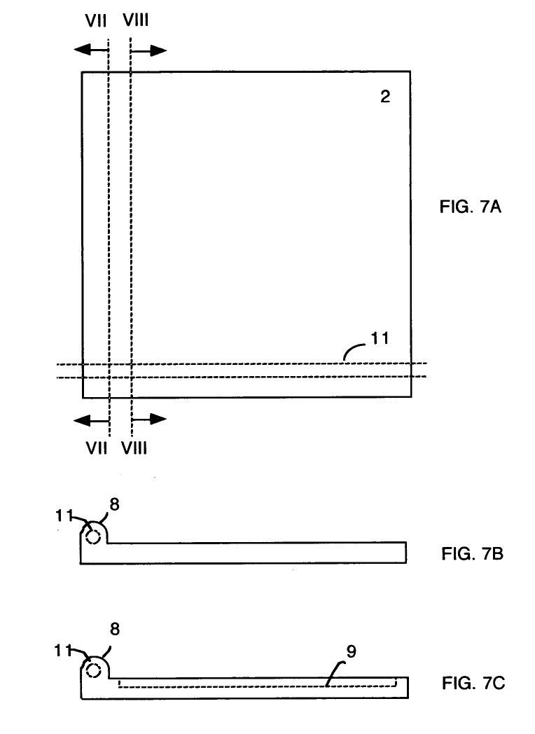

FIGS. 7a-7c show a mirror member for receipt by base member 1 as shown and described in FIGS. 5a-5e and 6a-6c. FIG. 7a shows mirror member 2, FIG. 7b shows a cross sectional view along line VII-VII of mirror member 2 and FIG. 7c shows a cross sectional view of mirror member 2 along line VIII-VIII. FIG. 7b shows mirror member 2 having a protruding, rounded side region 8 and aperture 11. Rounded side region 8 is prevented from rotation greater than a desired amount by the stepped region of the base member. Mirror member 2 typically rotates 170 degrees to 190 degrees relative to base member 1 to an open position from a closed position. Without a stepped region, member 2 is rotatable approximately 270 degrees relative to the base member. The cross sectional view along line VIII-VIII in FIG. 7b shows a region of the base of the mirror member at the edge region. In this region there is no mirrored surface. This is an edge region of base member 2j. Although mirror base 2j may be flat with a mirror glued thereon, it is preferred that the base of the mirror member includes a recessed region 9 so that edges of mirror are recessed or enclosed. This prevents an exposed sharp edge of a mirror when a mirror is glued to side 2e, for example. FIG. 6c shows cross sectional view where a dotted line shows recess 9 for receiving mirror 2j.

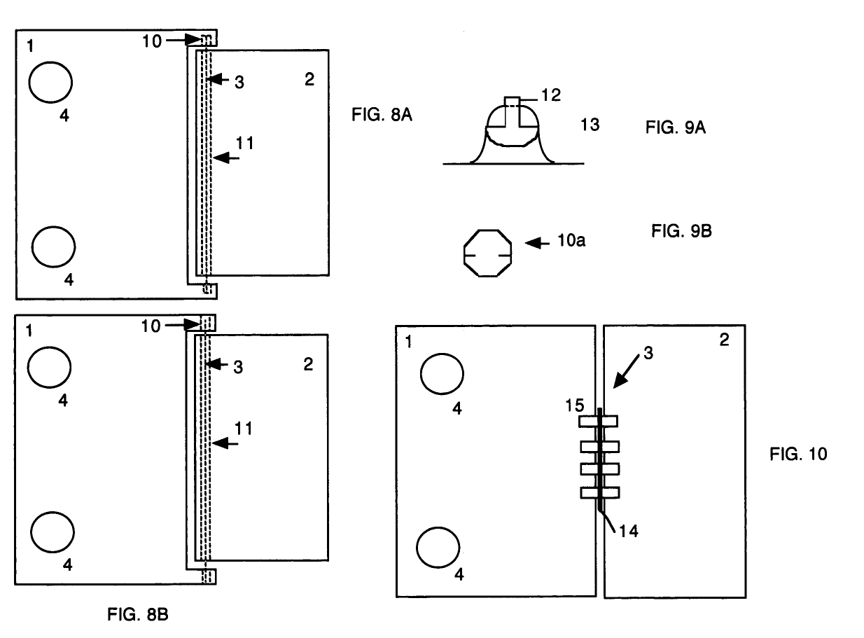

FIGS. 8 shows a fastening devices for rotatably joining base member 1 to mirror member 2. In FIG. 8, rod 12 is inserted through aperture 11 in mirror member 2. Rod 12 secures mirror member 2 to base member 1 by fitting in recesses 10. Rod 12 may be secured in recesses 10 by posts 13 shown in FIG. 9a. Posts may be integral with or secured in recesses 10. FIG. 9b shows a post member 10a integral with recess 10.

FIG. 10 shows a hinge 14 and bracket 15 arrangement for securing base member 1 to mirror member 2.

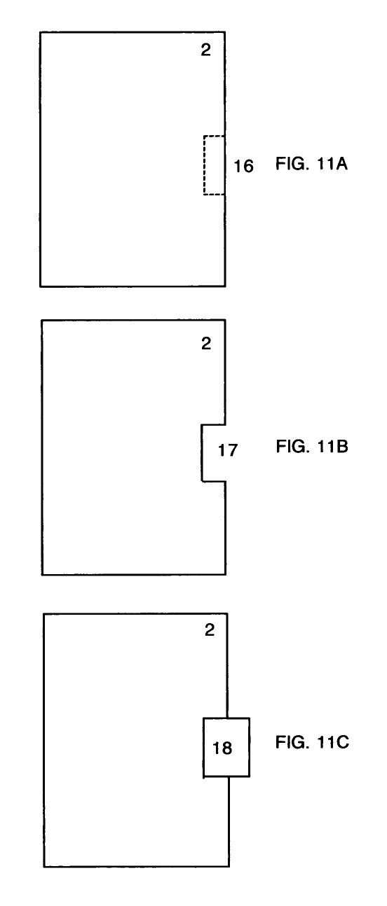

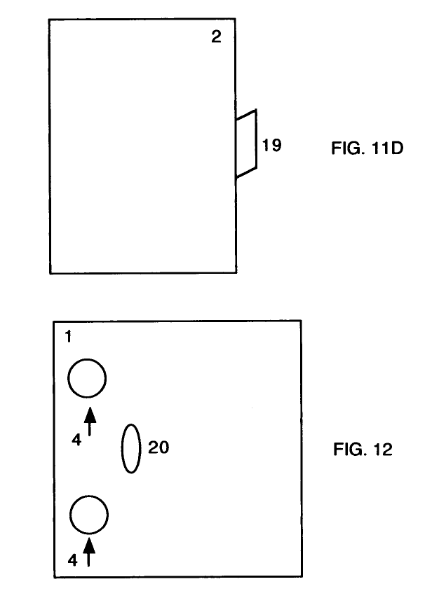

FIGS. 11a-11d show mirror member 2 including an opening device or feature. FIG. 11a shows mirror member 2 with an angled recess 16 to aide opening the binder mirror. FIG. 11b shows mirror member 2 with recess 17 to aide opening the binder mirror. It is not required that recess 17 extend to both exterior surfaces of mirror member 2. FIG. 11c shows mirror member 2 with extension 18 that may be integral, glued or hinged to base member 2. Extension 18 extends outwardly from the first edge or an alternate edge of mirror member 2. FIG. 11d shows mirror member 2 with extension 19 extending perpendicular to mirror member 2. FIG. 12 shows base member 1 with indentation or groove 20. Extension 19 is received by indentation 20, although extension 19 may be included without including indentation 20. Opening features may be made of the same material of the mirror base member.

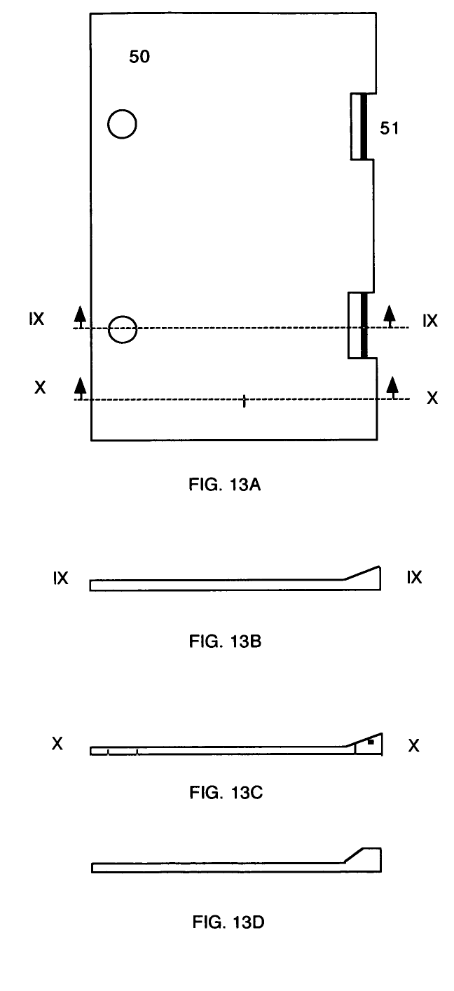

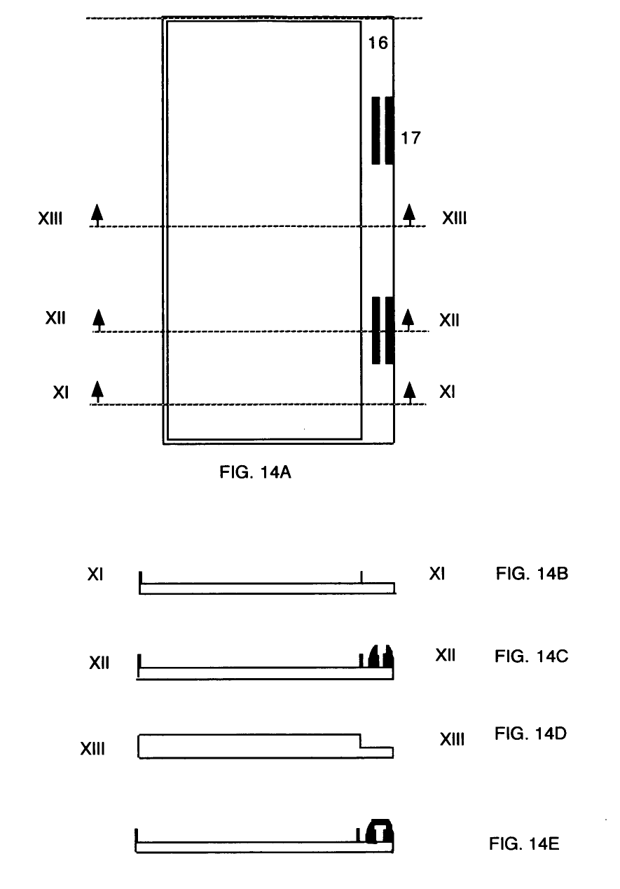

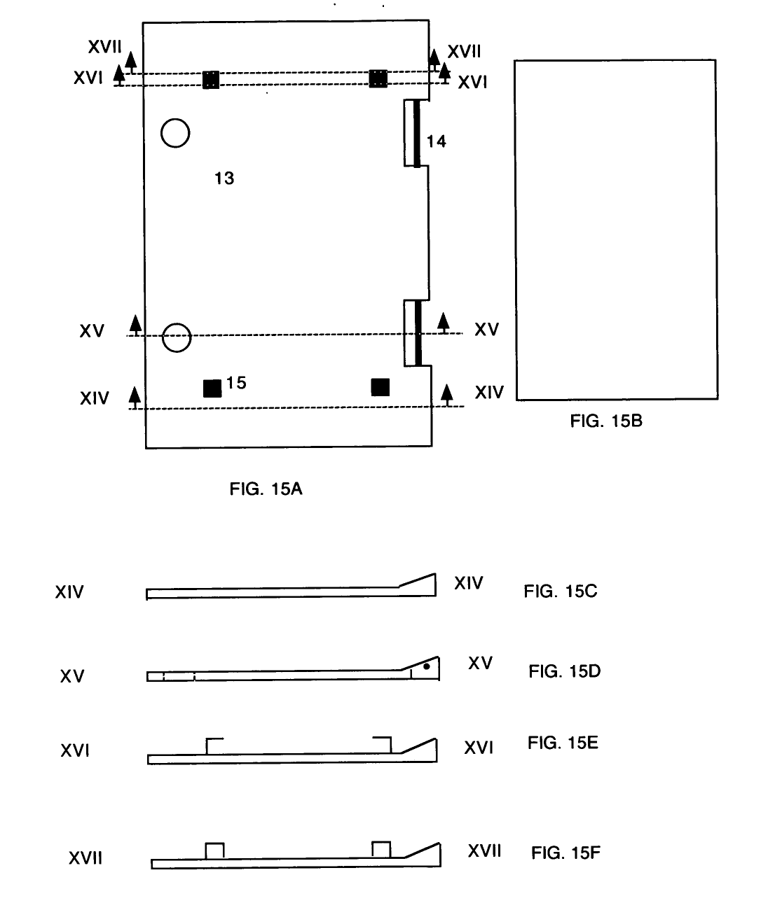

FIGS. 13A and 14A show a base member 50 and a mirror member 55 that have an integral fastening device that snaps together. FIG. 13A shows a base member 50 with bars 51 and apertures 4. FIGS. 13B and 13C show cross sectional views of the base member shown in FIG. 15. Note that the edge region of the base member may be modified as shown in FIG. 13D. An angled edge region is included to allow free rotation of the mirror member while maximizing mirror size.

FIG. 14A shows a top view of mirror member 55 with fastening elements 56 for releasably securing base member 50 and mirror member 55 by snapping the pieces together at bars 51. FIGS. 14B-14D show cross sectional views of mirror member 55. Elements 56 may be modified as show in FIG. 14E so that they are one piece 57.

FIG. 15A shows a base member including 4 protrusions, each with a recessed region for receiving paper or a picture, for examples. FIG. 15B shows a protective cover that may be included with the base member and the protrusions for protecting the paper or picture. FIGS. 15C-15F show cross sectional views of the base member with the four protrusions.

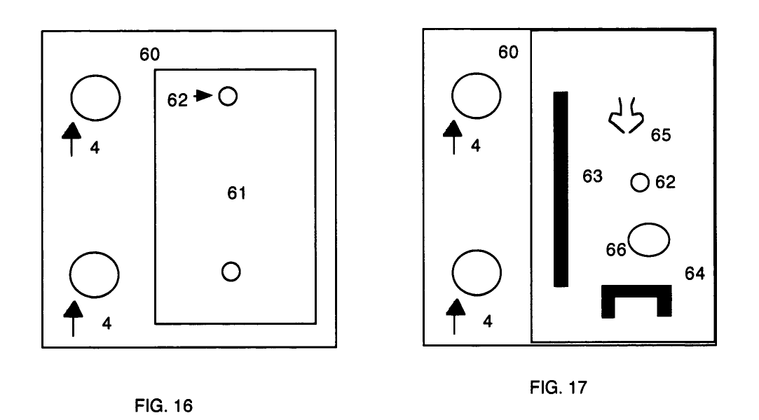

FIGS. 16 and 17 show base members including a variety of elements. For instance, base member 60 may include a magnetic region 61, an additional aperture 62, a protrusions 63 extending perpendicularly from the base member 60, a protrusion having three pieces 64, two pieces extending outward from the base member and a third piece joining theses two pieces so that the protrusion receives a back of a pad of paper and secures the paper therein, clip 65, for receiving a writing instrument, for example, and a band or sleeve 66 for receiving a stationary supply, for example. These elements may be included independently, in combination, and/or in various quantities in acceptable desired locations.

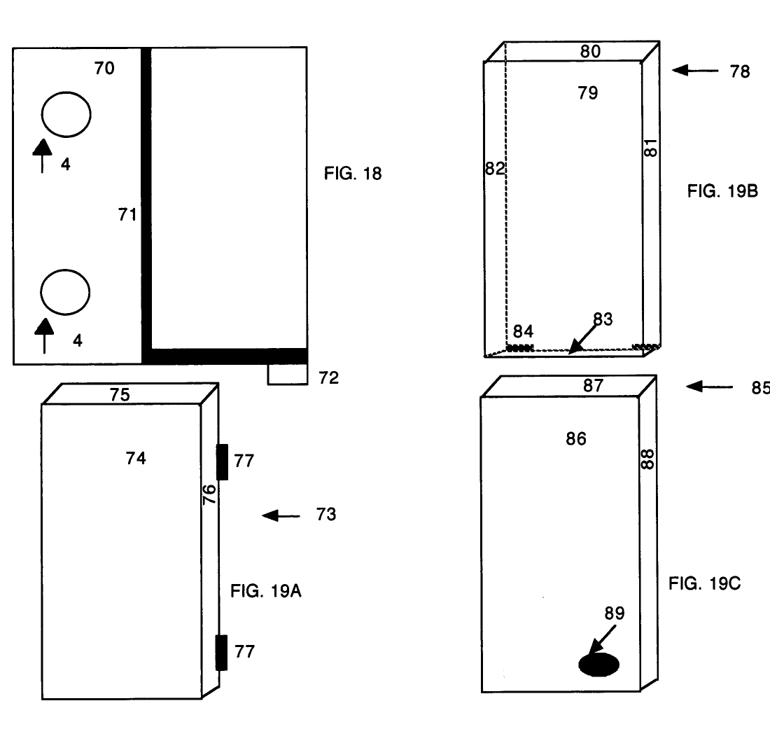

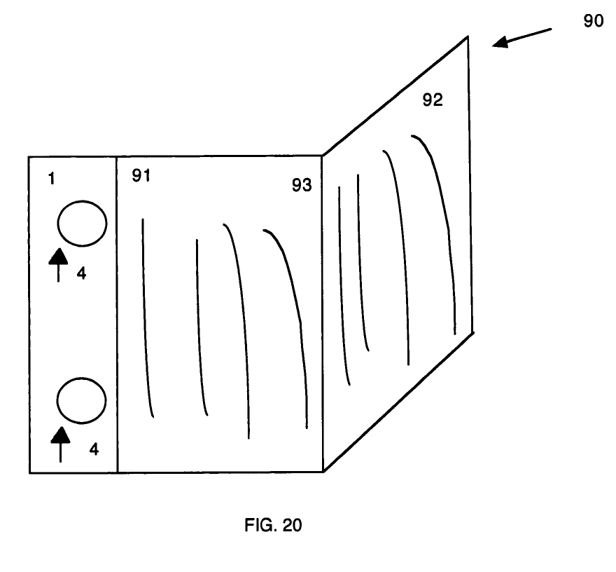

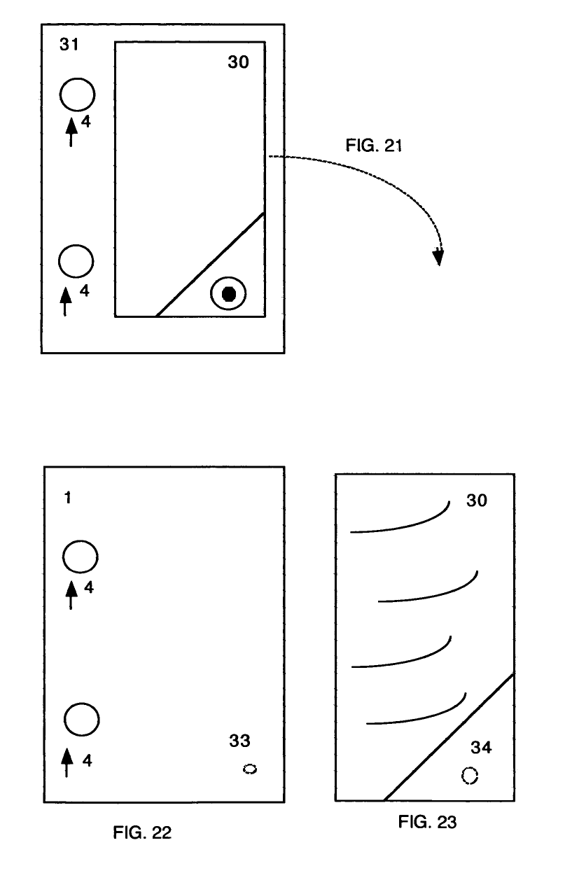

FIG. 18 and 19A-19C show a base member including an “L” shaped protrusion extending perpendicularly therefrom and various top members. These protrusions form a compartment between a base member and a top member, such as top member 73 shown in FIG. 19A. Top 19A includes 3 sides, a flat surface 74 being parallel to the base member in a closed position and, a width side 75, and a length side 76. Top 19A can be fastened to base member 70 along a side region, through a top side of the pieces, or on a front side of base member 70 with fastening device 77. The protrusions of a respective top member and possibly the base member define a compartment therein. The compartment sides may be defined by protrusions extending from the only the top. In the event both the base member and top include “L” shaped protrusions as shown in FIGS. 20 and 21A, ease of access to elements within the compartment is enhanced. In an open position, it is easy to slide a pen, for example, outward (parallel to the base member) of the compartment while lifting upward.

FIG. 19B shows a top member 78 with 5 sides, 79, 80, 81, 82, 83, 4 of the sides defining a compartment between the two parallel surfaces. Fastening elements 84 provide rotation of the top relative to the base. FIG. 19C show a top member 85 with three sides 86, 87, and 88 with fastening element 89 permitting rotation parallel to the base member If, for example, top member 85 is to rotate parallel to base member 70, an additional snap, possibly external and/or integral, and/or pressure fit may be included for stabilizing the top and base member when in a closed position. Also a swivel stop 72 may be included to prevent rotation of top 85 greater than a desired degree.

FIG. 20 shows a binder mirror similar to that of FIG. 1. The binder mirror 90 of FIG. 20 includes a receiving region in the base member 1 for receiving a mirror 91 in addition to mirror 92 in top member secured to base member by fastening device 93. The mirrors may vary in magnification. Mirror may be pressure fitted or bound to a receiving region.

FIGS. 21-27 show a second embodiment of the invention. FIG. 21 shows base member 31, mirror member 30 and fastening device 32. Base member 31 includes apertures 4. In addition, in the second embodiment base member 31 includes an additional recess or aperture 33 as shown in FIG. 22. FIG. 23 shows mirror member 30 with recess or aperture 34. Fastening device 32 secures mirror member 30 to base member 31. In this second embodiment, mirror member 30 swivels or rotates with respect to base member 1. FIG. 21 shows an arrow indicating clockwise rotation. Rotation of 360 degrees, in either a clockwise or counterclockwise direction, is possible. Alternately, a fastening device may be designed so that rotation from a rest position is limited to a desired amount in either a clockwise or counterclockwise direction, the desired amount being 90 degrees, 180 degrees or 270 degrees, for examples.

Fastening device 32 may extend through said base member and said mirror member and be secured on exterior surfaces of said base member and said mirror member. Alternatively, fastening device 32 may be recessed in said base member and said mirror member. Fastening device 32 possibly allows rotation of said mirror member to said base member 360 degrees above a plane parallel to base member 31, as shown by the dotted arrow in FIG. 21. Of course, a fastening device may include a stop to prevent rotation past a certain degree in either a clockwise or a counterclockwise direction.

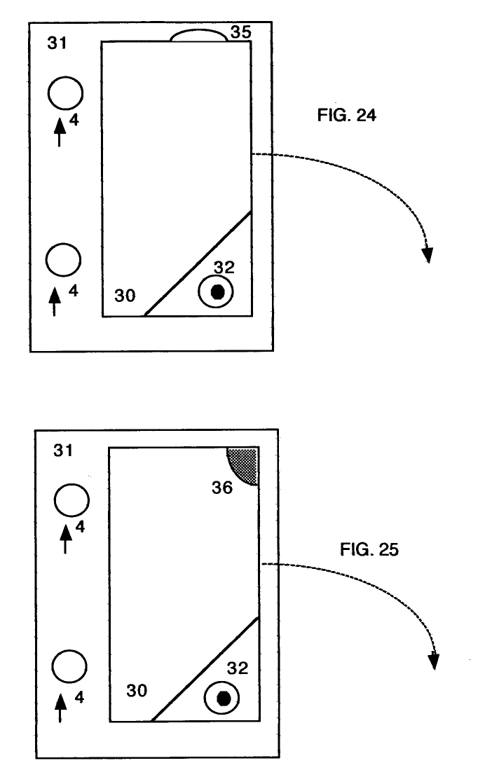

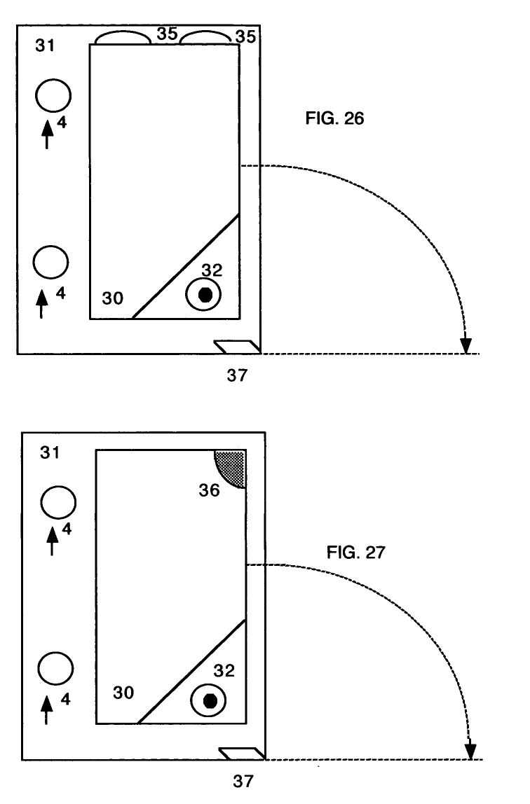

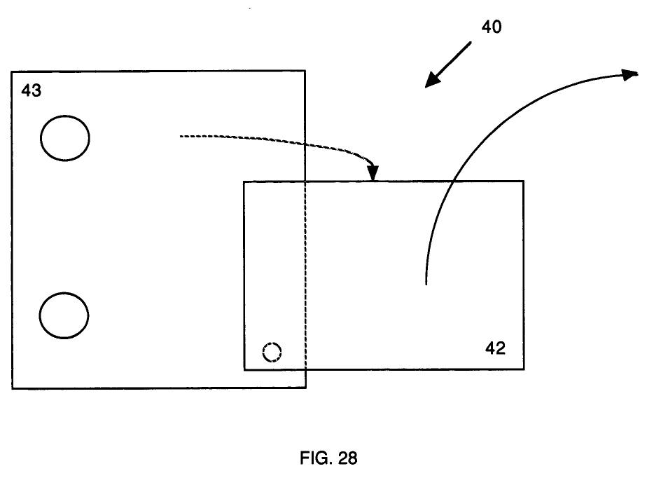

FIGS. 22 and 25 show the second embodiment of the invention with an opening device. The opening device enhances the ease of rotating the base member relative to the mirror member. Opening feature 35, shown in FIG. 24, is a pull handle to enhance the ease of swiveling or rotating mirror member 30 with respect to base member 31. FIG. 25 shows groove or indentation 36 in mirror member 30. Groove 30 is a gripping device to enhance the ease of swiveling or rotating mirror member 30 with respect to base member 31. FIGS. 26 and 27 show the second embodiment of the invention with protrusion or extension 37. Protrusion 37 prevents rotation or swiveling of mirror member 30 greater than 90 degrees, 135 degrees, 180 degrees, or 270 degrees with respect to the initial position of base member 1 and mirror member 30, for examples, depending on location relative to said mirror member.

As with the best mode of the invention, the three dimensional nature of both base member 31 and the mirror member 30 are designed to compliment one another. The mirror member typically includes a mirror base having a receiving region for a mirror. In addition, the mirror base includes additional area(s) to support a fastening device and an opening feature, if so desired. For example, an immediate area surrounding fastening device 32 does not receive a mirror. In the second embodiment, base member 31 may also be considered to have an aperture region as in the best mode of the invention. Base member 31 and base member 30 may be made from a rigid material as with the best mode of the invention, and of course, include a reflective surface or mirror, with mirror member 30.

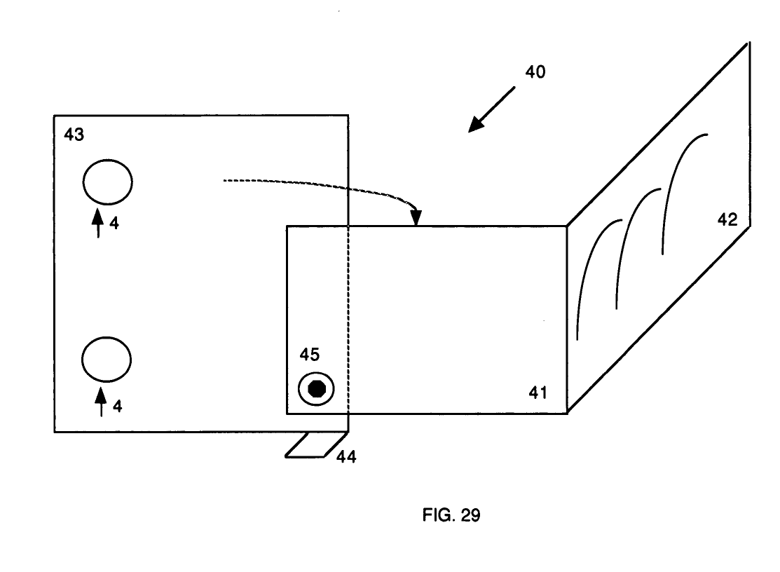

FIGS. 28 and 29 show a third embodiment of the invention. FIG. 28 shows a binder mirror according to the third embodiment of the invention having base member 43 and compact 40 with mirror member 42 rotated in a closed position. FIG. 29 shows base member 41, base of compact 40 rotated with respect to base member 43 and mirror member 42 open with respect to base member 41. FIG. 29 also shows optional swivel stop extension 44. Extension 44 prevents rotation or swiveling of compact base member 41 greater than a desired amount of 90 degrees, 135 degrees, 180 degrees or 270 degrees, for examples. Fastening devices 44 and 45 are similar to respective fastening devices in the best mode of the invention and the second embodiment of the invention.

A binder mirror of the present invention may include alternate shapes, mating arrangements and fastening devices consistent with the scope and spirit of the present invention.

1. A binder unit comprising:
a base member having:
a top surface;
a bottom surface;
a plurality of side surfaces;
at least one aperture extending through the base member from the top surface to the bottom surface; and
a top member having:
a mirror base having:
a top surface;
said top surface including a recess for said mirror;
a bottom surface;
a plurality of side surfaces; and
a fastening device rotatably securing said base member to said top member along one of:
one side of said plurality of sides of said mirror member,
said top surface of said mirror base, and
said bottom surface of mirror base member;
said mirror member being rotatable around a plane parallel to said top surface of said base member; and
said mirror member rotatable from a closed position to an open position and said mirror member not overlapping said at least one aperture of said base member in said closed position.

2. A binder unit according to claim 1, further comprising said fastening device being integral.

3. A binder unit according to claim 2, further comprising said fastening device being integral to said base member and said top member.

4. A binder unit according to claim 3, further comprising said base member and said top member snapping together at said fastening device.

5. A binder unit according to claim 3, further comprising said fastening device permanently securing said base member to said top member.

6. A binder unit according to claim 1, further comprising said base member including a recess for receiving a mirror.

7. A binder unit according to claim 1, further comprising said base member including at least one of a protrusion, a clip, a magnet, another aperture, and a sleeve.

8. A binder unit according to claim 7, further comprising:
said protrusion including four protrusion; and
each protrusion of said four protrusions including a recessed region between the base member and said respective protrusion.

9. A binder unit according to claim 8, further comprising a protective cover.

10. A binder unit according to claim 7, further comprising said base member including a clip for receiving a writing instrument.

11. A binder unit according to claim 1, further comprising a mirror secured to said top member.

12. A binder unit according to claim 6, further comprising a mirror secured to said base member.

13. A binder unit comprising:
a base member having a top surface;
said base member including at least one aperture;
a top member having a top surface;
said base member top surface having a surface area greater than a surface area of the top surface of the top member;
a fastening device;
at least one of said base member and said top member having at least one protrusion defining a compartment between said base member and said top member;
said top member including at least part of said protrusion defining said compartment.

14. A binder unit according to claim 13, further comprising:
said at least one protrusion including a first “L” shape protrusion extending from said base member and a second “L” shaped protrusion extending from said top member.

15. A binder unit according to claim 13, further comprising:
said base member including at least one of a recessed protrusion, a clip, a magnet, another aperture, and a sleeve.

16. A binder unit according to claim 13, further comprising said fastening device being integral.

17. A binder unit according to claim 13, further comprising said fastening device permitting rotation of said top member around said base member.

18. A binder unit according to claim 13, further comprising said fastening device permitting rotation of said top member above said base member.

19. A binder unit according to claim 13, further comprising said fastening device permitting rotation of said top member parallel to said base member.

20. A binder unit comprising:
a base member having:
a top surface;
a bottom surface;
a plurality of side surfaces;
at least one aperture extending through the base member from the top surface to the bottom surface; and
a top member having:
a mirror base having:
a top surface;
said top surface including a recess for said mirror;
a bottom surface;
a plurality of side surfaces; and
a fastening device rotatably securing said base member to said top member along one side of said plurality of sides of said mirror member,
said fastening device including at least one rod joining said base member and said top member;
said mirror member being rotatable around a plane parallel to said top surface of said base member; and
said mirror member rotatable from a closed position to an open position and said mirror member not overlapping said at least one aperture of said base member in said closed position.
